(19) United States
(12) Patent Application Publication
(10) Pub. No.: US 2019/0124438 A1
(43) Pub. Date: Apr. 25, 2019

(54) SPEAKER APPARATUS

(71) Applicant: DENSO TEN Limited, Kobe-shi (JP)

(72) Inventor: Masahiko KUBO, Kobe-shi (JP)

(73) Assignee: DENSO TEN Limited, Kobe-shi (JP)

(21) Appl. No.: 16/131,357

(22) Filed: Sep. 14, 2018

(30) Foreign Application Priority Data
Oct. 24, 2017 (JP) 2017-205649

(51) Int. Cl. H04R 1/32; H04R 1/28; H04R 9/06

(52) U.S. Cl. CPC H04R 1/323; H04R 9/063; H04R 1/2811

(57) ABSTRACT

A speaker apparatus according to an embodiment includes a first panel, a second panel, vibration elements, and a drive unit. The vibration elements are respectively provided to the first and second panels to vibrate the first and second panels. The drive unit applies a drive signal to the vibration elements so as to respectively form vibration regions in the first and second panels. The drive signal is obtained by modulating a carrier wave in an ultrasonic band by using a sound signal in an audible frequency band. The first and second panels are arranged so that an angle between surface directions of the first and second panels is a predetermined angle.

### CROSS-REFERENCE TO RELATED APPLICATION

This application is based upon and claims the benefit of priority of the prior Japanese Patent Application No. 2017-205649, filed on Oct. 24, 2017, the entire contents of which are incorporated herein by reference.

### FIELD

The embodiments discussed herein are directed to a speaker apparatus.

### BACKGROUND

Conventionally, there has been known a speaker apparatus having directivity, which is obtained by arranging a plurality of ultrasonic vibrators in array. This speaker apparatus is referred to as a “parametric array speaker” in some cases, and is capable of generating audible sound in a specific direction by applying, to the ultrasonic vibrators, voltage of an ultrasonic wave that is modulated by using a sound signal in an audible frequency band (see, e.g., Japanese Laid-open Patent Publication No. 2011-010224).

As such a speaker apparatus having a narrow directivity, there is also proposed a speaker apparatus that includes a vibrator in at least a part of a panel-shaped vibration plate so as to generate, by using vibration generated by the vibrator, standing wave in the vibration plate, and uses each antinode of this standing wave as a sound emitting unit so as to emit therefrom a sound wave having a directivity of a predetermined direction with respect to a surface of the panel.

However, this speaker apparatus has room for improvement in reducing sound emission in needless directions so as to improve its sound emitting efficiency.

### SUMMARY

A speaker apparatus according to an embodiment includes a first panel, a second panel, vibration elements, and a drive unit. The vibration elements are respectively provided to the first and second panels to vibrate the first and second panels. The drive unit applies a drive signal to the vibration elements so as to respectively form vibration regions in the first and second panels. The drive signal is obtained by modulating a carrier wave in an ultrasonic band by using a sound signal in an audible frequency band. The first and second panels are arranged so that an angle between surface directions of the first and second panels is a predetermined angle.

### BRIEF DESCRIPTION OF DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a perspective view illustrating a schematic configuration of a speaker apparatus according to a first embodiment;

FIG. 2 is a diagram illustrating advancing directions of ultrasonic waves that are generated from each band-like vibration region;

FIG. 3 is a block diagram illustrating the speaker apparatus according to the first embodiment;

FIG. 4 is a diagram illustrating a relation between band-like vibration regions and a standing wave that are formed in a panel;

FIG. 5 is a diagram illustrating a relation between the standing wave formed in the panel and directivity of the speaker apparatus;

FIG. 6 is a diagram illustrating relation between an angle at which ultrasonic waves intensify each other and advancing directions of the ultrasonic waves;

FIGS. 7A and 7B are diagrams illustrating advancing directions of first and second ultrasonic waves generated from each of the line-shaped resonance regions;

FIG. 8 is a diagram illustrating an arrangement example of the speaker apparatus according to the first embodiment;

FIG. 9 is a schematic side view illustrating a speaker apparatus according to a second embodiment; and

FIG. 10 is a block diagram illustrating the speaker apparatus according to the second embodiment.

### DESCRIPTION OF EMBODIMENTS

Hereinafter, embodiments of a speaker apparatus according to the present application will be described in detail with reference to the accompanying drawings. The present disclosure is not limited to the embodiments described in the following.

1. First Embodiment

1.1. Speaker Apparatus

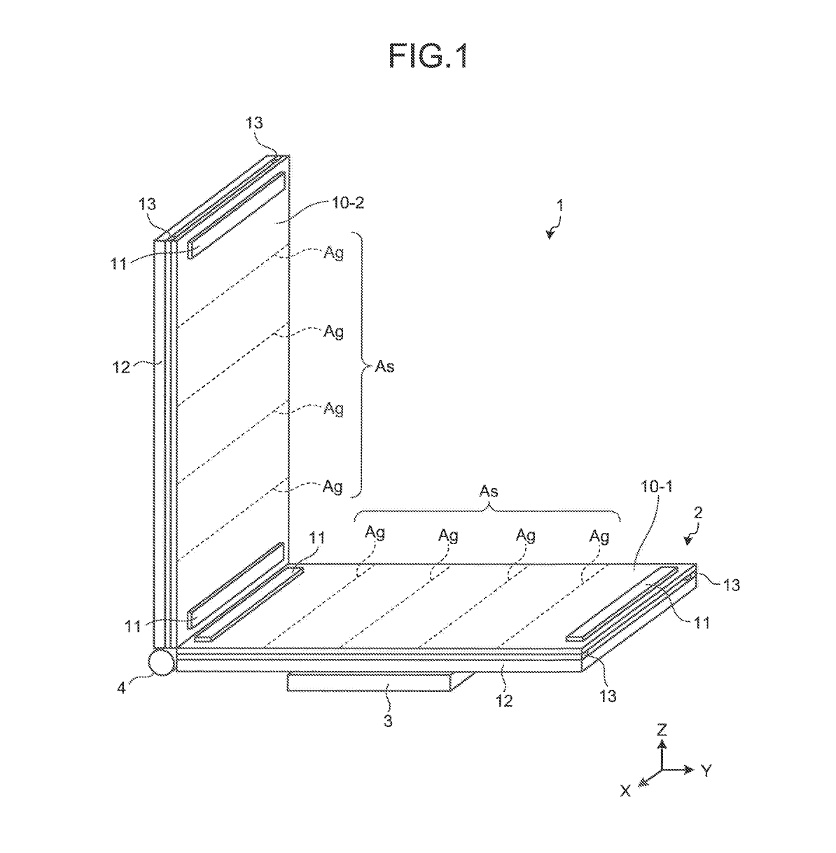

FIG. 1 is a perspective view illustrating a schematic configuration of a speaker apparatus according to a first embodiment. As illustrated in FIG. 1, a speaker apparatus 1 according to the first embodiment includes a sound outputting unit 2, a drive unit 3 that drives the sound outputting unit 2, and a connector 4. The sound outputting unit 2 includes a pair of panels 10-1 and 10-2.

The sound outputting unit 2 further includes: vibration elements 11 that are provided to each of the panels 10-1 and 10-2; and support parts 12 that respectively support the panels 10-1 and 10-2. The connector 4 connects the panels 10-1 and 10-2, supported by the respective support parts 12, with each other.

Each of the panels 10-1 and 10-2 is a plate-shaped member that is vibrated in response to vibration of the corresponding vibration elements 11, and is made of a material such as glass. Each of the panels 10-1 and 10-2 is fixed to the corresponding support part 12 via fixing members 13 to be supported by the corresponding support part 12. The vibration elements 11 include, for example, piezo elements, and are arranged on end parts of the panels 10-1 and 10-2, for example. Each of the vibration elements 11 expands and contracts in accordance with an Alternating-Current driving voltage (AC driving voltage) applied thereto so as to vibrate the panels 10-1 and 10-2.

The driving voltage to be applied to the vibration elements 11 is generated by the drive unit 3. The drive unit generates a driving voltage including a frequency component of an ultrasonic band (frequency band equal to or more than approximately 20 kHz) so as to generate a striped vibration region As on each of the panels 10-1 and 10-2. Specifically, the drive unit 3 amplifies a signal, which is obtained by modulating a carrier wave of the ultrasonic band by using a sound signal of an audible frequency band (less than approximately 20 kHz), so as to generate the driving voltage to be applied to the vibration elements 11.

The application of the driving voltage to the vibration elements 11 causes the panels 10-1 and 10-2 to vibrate and a standing wave is generated so as to form the striped vibration region As on each of the panels 10-1 and 10-2. Each of the striped vibration regions As includes a plurality of band-like vibration regions Ag, and these band-like vibration regions Ag function as band-like sound sources that emit ultrasonic waves modulated by a sound signal.

In the example illustrated in FIG. 1, the vibration elements 11, each of which extends in a lateral direction (X-axis direction) of the panel 10-1, are arranged on respective both end parts in a longitudinal direction (Y-axis direction) of the panel 10-1. The vibration elements 11 vibrate to form a standing wave in the longitudinal direction of the panel 10-1, and the plurality of band-like vibration regions Ag, each of which extends in the lateral direction (X-axis direction), is formed at equal intervals in the longitudinal direction (Y-axis direction).

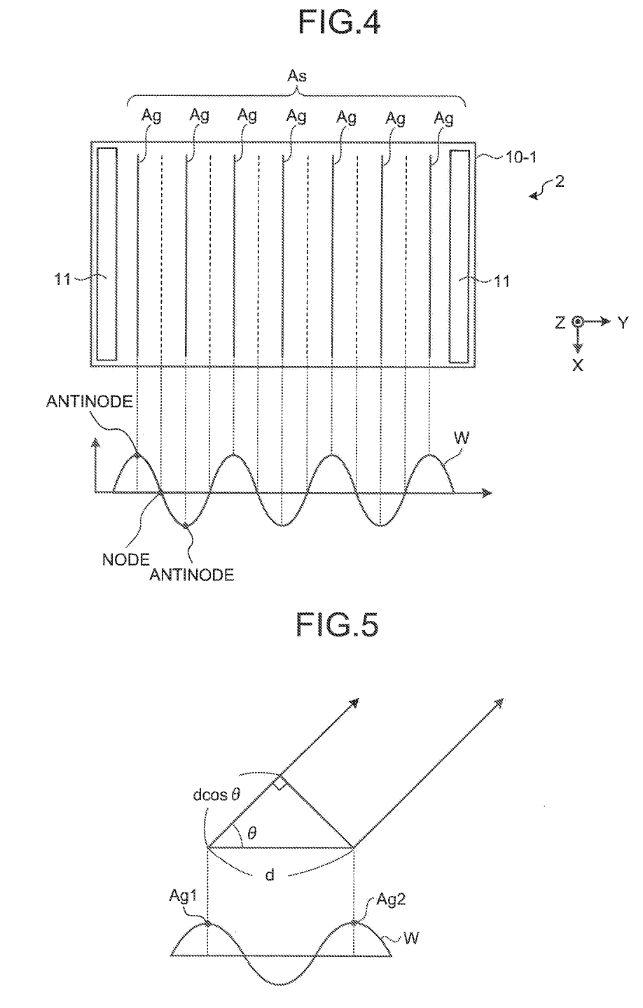

Furthermore, the vibration elements 11, each of which extends in a lateral direction (X-axis direction) of the panel 10-2, are arranged on respective both end parts in a longitudinal direction (Z-axis direction) of the panel 10-2. The vibration elements 11 vibrate to form a standing wave in the longitudinal direction (Z-axis direction), and the plurality of band-like vibration regions Ag, each of which extends in the lateral direction (X-axis direction), is formed at equal intervals in the longitudinal direction (Z-axis direction). In FIG. 1 (and FIG. 4, etc. to be described later), each of the band-like vibration regions Ag is indicated by using a line as one example of its “band-like” shape.

This speaker apparatus 1 generates, in a specific direction, a sound wave according to a sound signal by (i) intensification and interference between ultrasonic waves generated from the plurality of band-like vibration regions Ag that are formed in the aforementioned manner and (ii) a natural demodulation phenomenon caused by non-linear distortion of the modulated ultrasonic waves. Thus, the speaker apparatus 1 functions as a speaker apparatus having the narrow directivity.

Hereinafter, the pair of panels 10-1 and 10-2 may be collectively referred to as “panels 10”.

To generate the directivity in a direction perpendicular to the panel 10 is difficult because of effects of phase interference between ultrasonic waves in space. From each of the band-like vibration regions Ag, in addition to a first ultrasonic wave that advances in a first direction, a second ultrasonic wave is output that advances in a second direction. The second direction is a direction that is symmetrical to the first direction with respect to an axis along the direction perpendicular to the panel 10 when seen along the lateral direction of the panel 10 (X-axis direction).

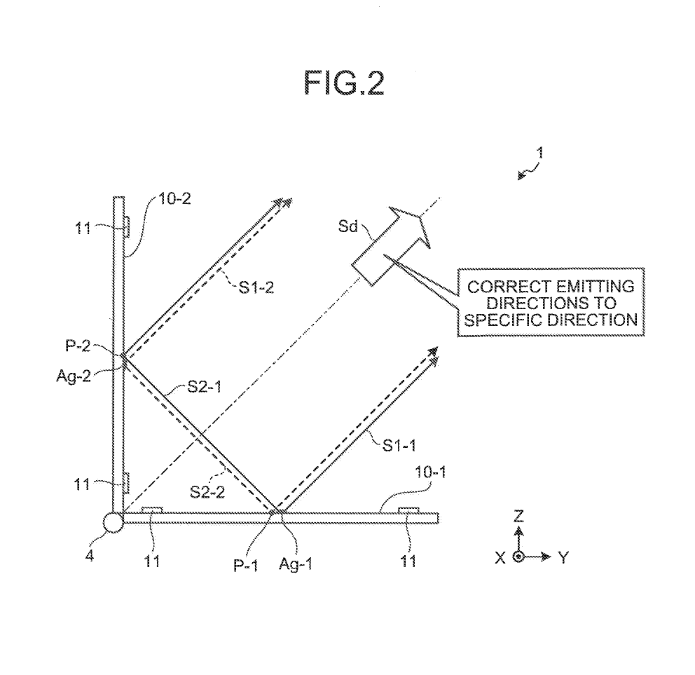

FIG. 2 is a diagram illustrating advancing directions of a first ultrasonic wave S1 and a second ultrasonic wave S2 that are generated from each of the band-like vibration regions Ag. In FIG. 2, reference symbols of the first ultrasonic wave S1 and the second ultrasonic wave S2, which are emitted from an arbitrary band-like vibration region Ag-1 of the panel 10-1, are provided with “-1”. Similarly, reference symbols of the first ultrasonic wave S1 and the second ultrasonic wave S2, which are emitted from an arbitrary band-like vibration region Ag-2 on the panel 10-2, are provided with “-2”.

As illustrated in FIG. 2, a first ultrasonic wave S1-1 and a second ultrasonic wave S2-1, which are emitted from the band-like vibration region Ag-1 of the panel 10-1, advance symmetrically with respect to the direction (Z-axis direction) perpendicular to the panel 10-1. Therefore, if it were not for the panel 10-2 illustrated in FIG. 2, the first ultrasonic wave S1-1 and the second ultrasonic wave S2-1 would advance in different directions from the band-like vibration region Ag-1 of the panel 10-1.

In other words, when the panel 10-1 is not provided with the panel 10-2, sound waves having a narrow directivity are emitted in two directions from the band-like vibration region Ag-1 of the panel 10-1, and thus, when a sound wave having a narrow directivity is emitted in one desired direction, a needless sound wave is to be emitted in another direction.

Similarly, a first ultrasonic wave S1-2 and a second ultrasonic wave S2-2, which are emitted from the band-like vibration region Ag-2 of the panel 10-2, advance symmetrically with respect to the direction (Y-axis direction) perpendicular to the panel 10-2. Therefore, if it were not for the panel 10-1 illustrated in FIG. 2, the first ultrasonic wave S1-2 and the second ultrasonic wave S2-2 would advance in different directions from the band-like vibration region Ag-2 of the panel 10-2.

In other words, when the panel 10-2 is not provided with the panel 10-1, sound waves having a narrow directivity are emitted in two directions from the band-like vibration region Ag-2 of the panel 10-2, and thus, when a sound wave having a narrow directivity is emitted in one desired direction, a needless sound wave is to be emitted in another direction.

As described above, the speaker apparatus 1 according to the present embodiment includes the pair of panels 10-1 and 10-2. The panels 10-1 and 10-2 are arranged so that an angle between surface directions of these panels 10-1 and 10-2 is a predetermined angle. For example, the panel 10-2 is arranged so that the direction of the panel 10-2 intersects with the surface of the panel 10-1. For example, as illustrated in FIGS. 1 and 2, the panel 10-2 is arranged so that the direction of the panel 10-2 is perpendicular to the surface of the panel 10-1.

In this case, the connector 4 connects the panels 10-1 and 10-2 with each other to hold them so that the angle between the panels 10-1 and 10-2 is an angle of 90 degrees. In FIGS. 1 and 2, a case is exemplified where the connector 4 closely holds the panels 10-1 and 10-2; however, a clearance may be preferably provided between the panels 10-1 and 10-2 so as to prevent one of the panels 10-1 and 10-2 from inhibiting vibration of the other. The connector 4 may adjust the angle between the panels 10-1 and 10-2. This point will be mentioned later, as a second embodiment, with reference to FIG. 9 and the following.

As illustrated in FIG. 2, when the pair of panels 10-1 and 10-2 is arranged as described above, the second ultrasonic wave S2-1 generated from the band-like vibration region Ag-1 of the panel 10-1 is able to be reflected from a reflection point P-2 of the panel 10-2. Thus, it is possible to bring the advancing direction of the second ultrasonic wave S2-1 close to both of the advancing direction of the first ultrasonic wave S1-1 and the advancing direction of the first ultrasonic wave S1-2 that is generated from the band-like vibration region Ag-2 of the panel 10-2.

The second ultrasonic wave S2-2 generated from the band-like vibration region Ag-2 of the panel 10-2 is able to be reflected from a reflection point P-1 of the panel 10-1. Thus, it is possible to bring the advancing direction of the second ultrasonic wave S2-2 close to both of the advancing directions of the first ultrasonic waves S1-1 and S1-2.

In other words, it is possible to correct, to a specific direction Sd, emitting directions of the first ultrasonic wave S1 and the second ultrasonic wave S2 that are respectively emitted from the band-like vibration region Ag-1 of the panel 10-1 and the band-like vibration region Ag-2 of the panel 10-2.

Therefore, sound emission in needless directions of the first ultrasonic wave S1 and the second ultrasonic wave S2 that are emitted from the band-like vibration regions Ag of the panels 10 is reduced, so that it is possible to improve sound emitting efficiency.

In other words, the panel 10-2 is arranged so that the direction of the panel 10-2 intersects with the panel 10-1 at a predetermined angle. This predetermined angle is set so as to bring an advancing direction of the second ultrasonic wave S2-1, which has been generated from the band-like vibration region Ag-1 of the panel 10-1 and reflected from the panel 10-2, close to an advancing direction of the second ultrasonic wave S2-2 that has been generated from the band-like vibration region Ag-2 of the panel 10-2 and reflected from the panel 10-1.

As described above, the speaker apparatus 1 according to the present embodiment is provided with the pair of panels 10-1 and 10-2, and the pair of panels 10-1 and 10-2 is arranged so that surface directions of the pair of panels 10-1 and 10-2 make a predetermined angle by using each other as a reflection plate, so that it is possible to correct directions of the first ultrasonic wave S1 and the second ultrasonic wave S2 to the specific direction Sd. Therefore, by employing the speaker apparatus 1 according to the present embodiment, sound emission in needless directions is reduced, so that it is possible to improve sound emitting efficiency.

In the example illustrated in FIGS. 1 and 2, the surface directions of the panels 10-1 and 10-2 are perpendicular to each other, in other words, a predetermined angle between the panels 10-1 and 10-2 is an angle of 90 degrees; however, individual difference in the emission angle of the ultrasonic wave may present in each of the panels 10-1 and 10-2, and thus it is not needed that the predetermined angle is an angle of exactly 90 degrees and may be substantially 90 degrees in consideration of this individual difference and the like. It is sufficient that the emitting direction of the ultrasonic wave is corrected to be close to the specific direction Sd, and thus the predetermined angle is not limited to an angle of 90 degrees. Hereinafter, the configuration of the speaker apparatus 1 according to the first embodiment will be explained more specifically.

1.2. Specific Configuration of Speaker Apparatus

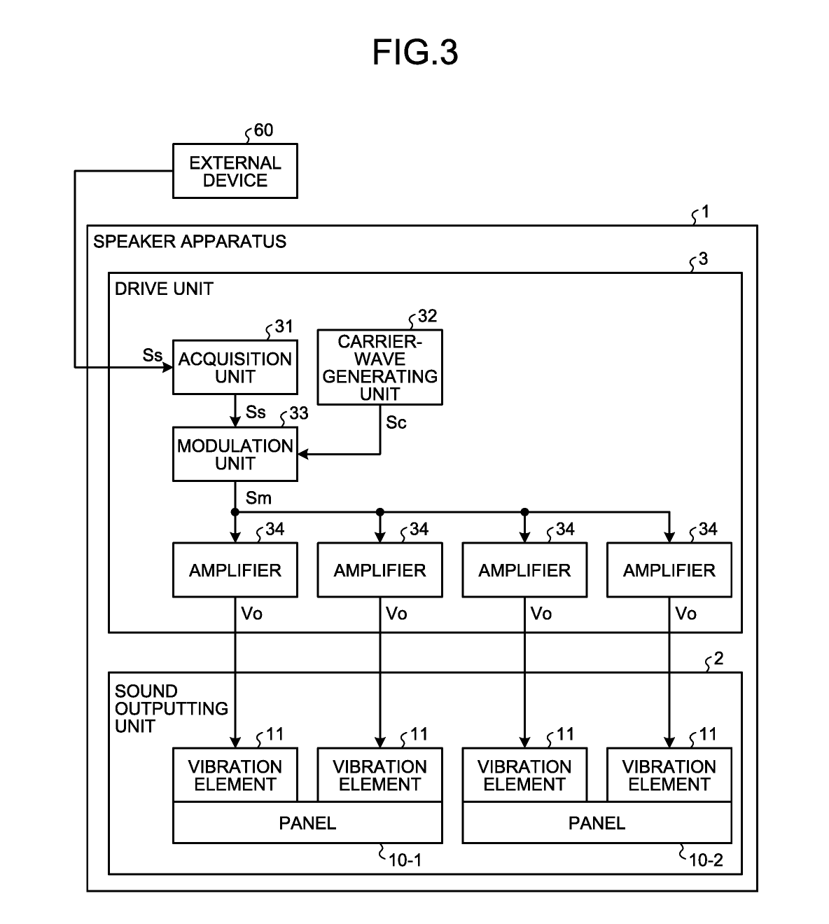

FIG. 3 is a block diagram illustrating the speaker apparatus 1 according to the first embodiment. In FIG. 3, only configuration elements that are needed for explaining features of the present embodiment are illustrated by using functional blocks, and illustration of common configuration elements is omitted.

In other words, specific forms of distribution and integration of the configuration elements illustrated in FIG. 3 are not limited to those illustrated in the drawings, and all or some of the devices can be configured by separating or integrating the apparatus functionally or physically in any unit, according to various types of loads, the status of use, etc.

As illustrated in FIG. 3, the speaker apparatus 1 includes the sound outputting unit 2 and the drive unit 3.

1.2.1. Sound Outputting Unit

The sound outputting unit 2 includes, as described above, the pair of panels 10-1 and 10-2, and the vibration elements 11 that are arranged in each of the panels 10-1 and 10-2.

Each of the panels 10-1 and 10-2 is a plate-shaped member having a rectangular shape and is vibrated in accordance with vibration of the vibration elements 11. Each of the panels 10-1 and 10-2 is formed by using a material such as glass; however, not limited thereto, another member made of metal, plastic, or the like may be employed. Each of the panels 10-1 and 10-2 may have, not limited to the rectangular shape, another shape such as a square shape, a circular shape, and a triangular shape.

Each of the panels 10-1 and 10-2 is fixed to the corresponding support part 12 (see FIG. 1) by the fixing members 13 (see FIG. 1). The fixing members 13 are made of, for example, thermoset resin that is cured by heat; however, not limited thereto, adhesion tapes, fixing tools (for example, screws) for fixing each of the panels 10-1 and 10-2 and the corresponding support part 12 therebetween, or the like may be appropriately employed. It is preferable that the fixing members 13 are members that are hardly deformed after the fixing in order to prevent the fixing members 13 from absorbing vibration of the vibration elements 11.

Both end parts of each of the panels 10-1 and 10-2 in the lateral direction thereof are fixed to the corresponding support part 12 by the fixing members 13. In this manner, both end parts of each of the panels 10-1 and 10-2 in the lateral direction are fixed along the longitudinal direction thereof, and thus flexure of the panels 10-1 and 10-2 generated by vibration thereof is reduced. Thus, it is possible to suppress, in the panels 10-1 and 10-2, inhibition of generation of a standing wave or reduction in sound pressure. It is sufficient that fixed positions of each of the panels 10-1 and 10-2 to the support part 12 are for reducing flexure of the corresponding panel 10-1 or 10-2, and are not limited to both end parts of the panels 10-1 and 10-2 in the lateral direction.

Both ends of each of the panels 10-1 and 10-2 in the longitudinal direction are not fixed by the fixing members 13, and are fixed to the support part 12 while interposing a gap therebetween. Therefore, back pressure, which is the pressure generated on a reverse-face side of each of the panels 10-1 and 10-2, is able to be released from the above-mentioned gap, and thus it is possible to reduce inhibition of vibration of each of the panels 10-1 and 10-2, which is caused by rebound of the back pressure from the corresponding panel 10-1 or 10-2. Another member other than the fixing members 13 may be employed to generate this gap, alternatively, a vibration controlling member for absorbing the back pressure may be arranged on or above the back surface of each of the panels 10-1 and 10-2.

Although not illustrated in FIG. 3 because FIG. 3 is a block diagram, the panels 10-1 and 10-2 are arranged so that an angle between the panels 10-1 and 10-2 is a predetermined angle, as described above.

Specifically, the panel 10-2 is arranged so that the direction of the panel 10-2 intersects with the panel 10-1 at a predetermined angle (for example, 90 degrees). This predetermined angle is set so as to bring an advancing direction of the second ultrasonic wave S2-1, which has been generated from the band-like vibration region Ag-1 of the panel 10-1 and reflected from the panel 10-2, close to an advancing direction of the second ultrasonic wave S2-2 that has been generated from the band-like vibration region Ag-2 of the panel 10-2 and reflected from the panel 10-1.

As described above, the vibration elements 11 include piezo elements, it is sufficient that they are capable of vibrating at a frequency corresponding to a driving voltage Vo supplied from the drive unit 3, and thus may include vibration elements other than the piezo elements. In the example illustrated in FIG. 3, the case is exemplified in which the number of the vibration elements 11, provided to each of the panels 10-1 and 10-2, is two; however, the number of the vibration elements 11 provided to each of the panels 10-1 and 10-2 may be one or equal to or more than three.

1.2.2. Drive Unit

The drive unit 3 generates the driving voltage Vo for causing the vibration elements 11 to vibrate, and applies the generated driving voltage Vo to the vibration elements 11. The vibration elements 11 expand and contract by the driving voltage Vo supplied from the drive unit 3 to vibrate the panels 10-1 and 10-2, and generates, in each of the panels 10-1 and 10-2, the striped vibration region As including the plurality of band-like vibration regions Ag.

As illustrated in FIG. 3, the speaker apparatus 1 is connected to an external device 60, vibrates the panels 10-1 and 10-2 on the basis of a sound signal Ss input from the external device 60, and generates ultrasonic waves according to a carrier wave Sc modulated by the sound signal Ss.

The external device 60 is a device that outputs, to the speaker apparatus 1, the sound signal Ss of the audible frequency band (band less than approximately 20 kHz), and is able to output the sound signal Ss to the outside, such as an audio device, a car navigation device, a smartphone, and a Personal Computer (PC).

The drive unit 3 includes an acquisition unit 31, a carrier-wave generating unit 32, a modulation unit 33, and amplifiers 34 so as to generate the driving voltage Vo for causing the vibration elements 11 to vibrate, and applies the generated driving voltage Vo to the vibration elements 11. The drive unit 3 includes (i) a computer, which includes, for example, a Central Processing Unit (CPU), a Read Only Memory (ROM), Random Access Memory (RAM), a Hard Desk Drive (HDD), an input/output port, etc. and (ii) various circuits such as amplification circuits.

The CPU of the computer reads and executes various programs stored in the ROM, for example, and functions as the acquisition unit 31, the carrier-wave generating unit 32, and the modulation unit 33 of the drive unit 3. All or a part of the acquisition unit 31, the carrier-wave generating unit 32, and the modulation unit 33 of the drive unit 3 may be constituted of hardware such as an Application Specific Integrated Circuit (ASIC) and a Field Programmable Gate Array (FPGA). The amplifiers 34 are constituted of amplification circuits such as power amplifiers.

The acquisition unit 31 acquires the sound signal Ss output from the external device 60 and outputs the acquired sound signal Ss to the modulation unit 33. The acquisition unit 31 is also able to adjust the gain (amplitude) of the sound signal Ss and output the adjusted sound signal Ss to the modulation unit 33. The acquisition unit 31 may include a low-pass filter through which a signal in the audible frequency band passes, by employing this low-pass filter, it is possible to remove a signal in a band other than the audible frequency band.

The carrier-wave generating unit 32 generates the carrier wave Sc and outputs the generated carrier wave Sc to the modulation unit 33. The carrier wave Sc is a sine-wave signal, in the ultrasonic band, causes each of the panels 10-1 and 10-2 to generate a standing wave, and has a frequency for forming the striped vibration region As.

The modulation unit 33 generates the modulation signal Sm, which is a signal obtained by modulating the carrier wave Sc input from the carrier-wave generating unit 32 by using the sound signal Ss input from the acquisition unit 31, and outputs the generated modulation signal Sm to the amplifiers 34. The modulation unit 33 performs the modulation by Amplitude-Modulation modulation (AM modulation) or Frequency-Modulation modulation (FM modulation). The AM modulation is Double Sideband modulation (DSB modulation) or Single Sideband modulation (SSB modulation), for example.

The modulation signal Sm output from the modulation unit 33 to the amplifiers 34 is amplified by each of the amplifiers 34, and is applied to the corresponding vibration element 11 as the driving voltage Vo having an AC voltage according to the waveform of the modulation signal Sm. The vibration elements 11 expand and contract in accordance with the applied driving voltage Vo so as to cause each of the panels 10-1 and 10-2 to generate a standing wave. Antinodes of these standing waves become the band-like vibration regions Ag.

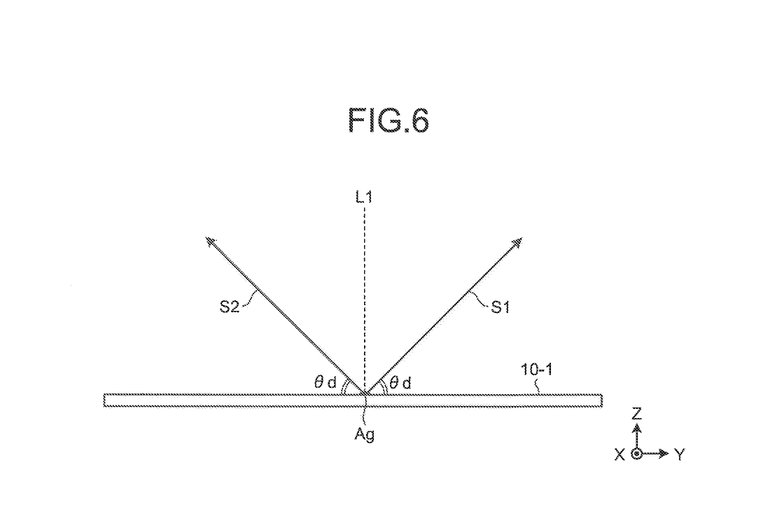

FIG. 4 is a diagram illustrating a relation between the band-like vibration regions Ag formed in the panels 10 and the standing wave W. For convenience of explanation, the panel 10-1 is illustrated in FIG. 4; however, the same is true of the panel 10-2. The same is true of FIG. 6

In FIG. 4, antinodes of the standing wave W are indicated by using solid lines and nodes of the standing wave W are indicated by using dashed lines, and the antinode parts of the standing wave W function as the band-like vibration regions Ag. The antinode parts of the standing wave W are generated at equal intervals along the longitudinal direction of the panel 10-1, and thus the band-like vibration regions Ag are generated at equal intervals along the longitudinal direction (Y-axis direction) of the panel 10-1. In FIG. 4, for convenience of explanation, the example is illustrated in which the seven band-like vibration regions Ag are generated by the standing wave W in the longitudinal direction of the panel 10-1, the number of the band-like vibration regions Ag is not limited to seven, and is greater as the frequency of the carrier wave Sc is higher.

Next, the directivity of the speaker apparatus 1 will be explained. FIG. 5 is a diagram illustrating a relation between the standing wave W formed in the panels 10 and directivity of the speaker apparatus 1. In FIG. 5, for convenience of explanation, the standing wave W is partially illustrated. Adjacent antinodes of the standing wave W having the same phase are illustrated as the band-like vibration regions Ag1 and Ag2, and an angle θ is illustrated that is an angle, with respect to the panel 10, of ultrasonic waves generated from the band-like vibration regions A1 and Ag2.

The phase of one of the ultrasonic waves generated from the band-like vibration regions Ag1 and Ag2 is shifted from the phase of the other by a distance (d×cos θ) with respect to the arbitrary angle θ. When a wavelength of the carrier wave Sc is “λ”, the ultrasonic waves generated from the band-like vibration regions Ag1 and Ag2 cancel each other at the angle θ where the distance (d×cos θ) is equal to odd number times of a wavelength λ/2. In other words, the ultrasonic waves are cancelled at the angle θ where the distance (d×cos θ) is equal to odd number times of the wavelength λ/2. On the other hand, the ultrasonic waves generated from the band-like vibration regions Ag1 and Ag2 intensify each other at the angle θ where the distance (d×cos θ) is equal to integer number times of the wavelength λ (namely, even number times of wavelength λ/2). Sound wave of the audible frequency band is generated by a natural demodulation phenomenon caused by non-linear distortion of the ultrasonic waves when the ultrasonic waves propagate in the space or when the ultrasonic waves are reflected from an object.

As described above, the ultrasonic waves generated from the plurality of band-like vibration regions Ag phase-interfere (intensify and cancel) with each other to be able to advance the ultrasonic waves in a specific direction. A sound wave of the audible frequency band is generated by a natural demodulation phenomenon caused by non-linear distortion of the ultrasonic waves, and thus the speaker apparatus 1 is able to have a narrow directivity in the specific direction.

As described above, the speaker apparatus 1 has a narrow directivity in a specific direction, the angles θ (hereinafter, may be referred to as “angles θd”) at which ultrasonic waves intensify each other symmetrically exist with respect to an axis perpendicular to the panel 10.

FIG. 6 is a diagram illustrating relation between the angle θd at which ultrasonic waves intensify each other and advancing directions of the ultrasonic waves. As illustrated in FIG. 6, the first ultrasonic wave S1 and the second ultrasonic wave S2, which are generated at the angle θd from each of the band-like vibration regions Ag, advance in respective directions that are symmetrical with respect to a corresponding axis L1 perpendicular to the panel 10-1.

Therefore, as described above, the speaker apparatus 1 according to the present embodiment is provided with the pair of panels 10-1 and 10-2 whose surface directions are arranged to make a predetermined angle, and one of the pair of panels 10-1 and 10-2 is used as a reflection plate of the other in order to correct directions of the first ultrasonic wave S1 and the second ultrasonic wave S2 emitted from each of the panels 10-1 and 10-2 to the specific direction Sd.

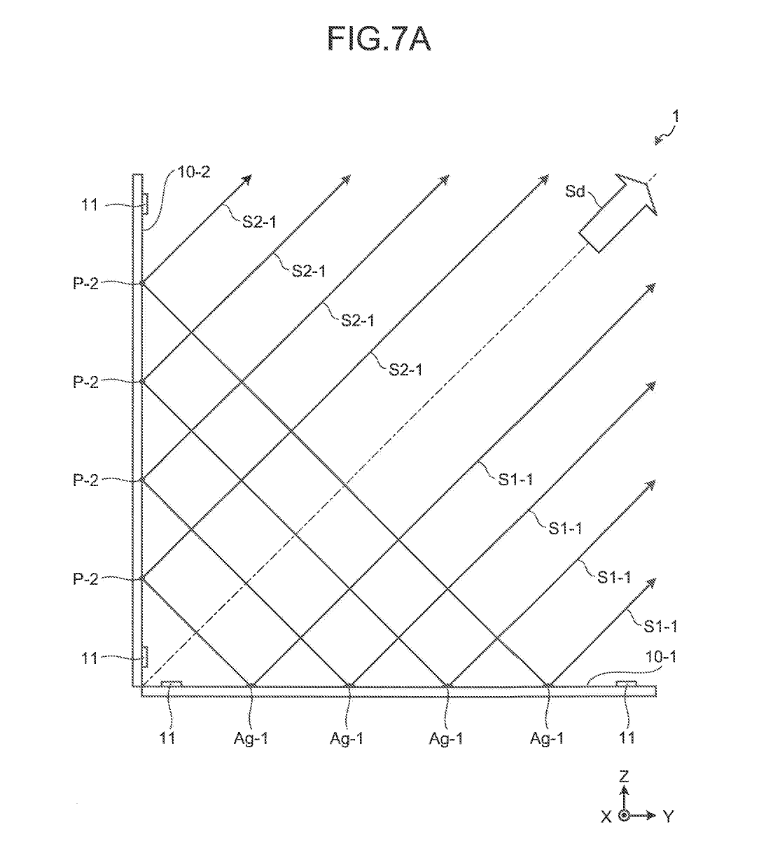

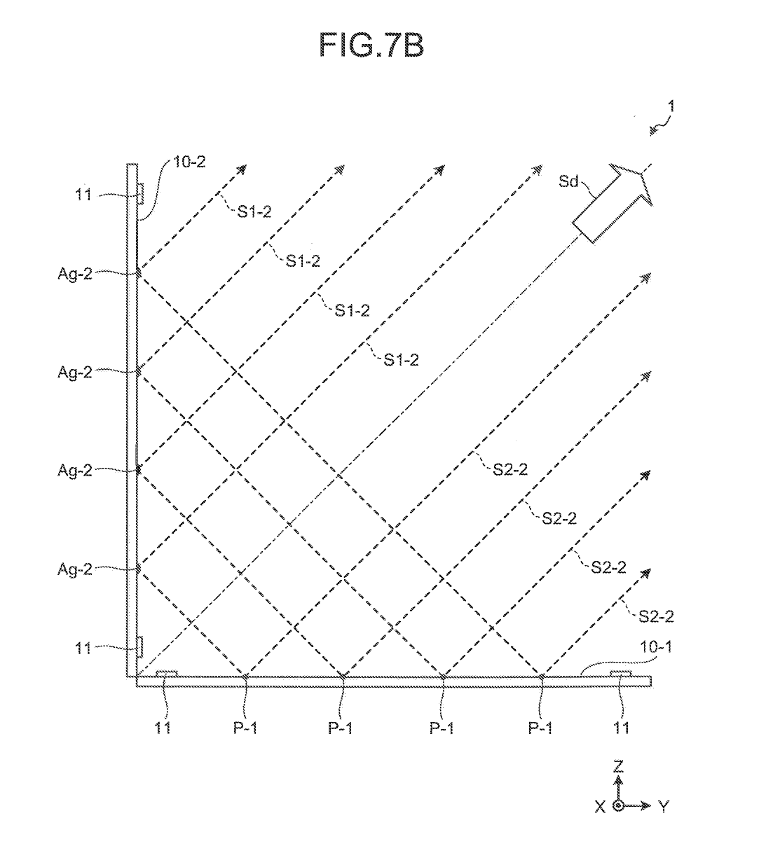

FIGS. 7A and 7B are diagrams illustrating advancing directions of the first ultrasonic wave S1 and the second ultrasonic wave S2 generated from each of the band-like vibration regions Ag. In FIG. 7A, the first ultrasonic wave S1-1 and the second ultrasonic wave S2-1 generated from each of the band-like vibration regions Ag-1 of the panel 10-1 are illustrated. In FIG. 7B, the first ultrasonic wave S1-2 and the second ultrasonic wave S2-2 generated from each of the band-like vibration regions Ag-2 of the panel 10-2 are illustrated.

As described above, as illustrated in FIGS. 7A and 7B, the panels 10-1 and 10-2 are arranged so that surface directions thereof make an angle of substantially 90 degrees. Therefore, as illustrated in FIG. 7A, the second ultrasonic wave S2-1 generated from each of the band-like vibration regions Ag-1 of the panel 10-1 is reflected from the corresponding reflection point P-2 of the panel 10-2, and an advancing direction of the second ultrasonic wave S2-1 is reversed. Thus, an advancing direction of the second ultrasonic wave S2-1 and that of the first ultrasonic wave S1-1 becomes substantially similar to each other.

As illustrated in FIG. 7B, the second ultrasonic wave S2-2 generated from each of the band-like vibration regions Ag-2 of the panel 10-2 is reflected from the corresponding reflection point P-1 of the panel 10-1, and an advancing direction of the second ultrasonic wave S2-2 is reversed. Thus, the advancing direction of the second ultrasonic wave S2-2 and that of the first ultrasonic wave S1-2 becomes substantially similar to each other.

In other words, as illustrated in FIGS. 7A and 7B, all of the advancing directions of the first ultrasonic wave S1-1 and the second ultrasonic wave S2-1, which are emitted from each of the band-like vibration regions Ag-1 of the panel 10-1, and the advancing directions of the first ultrasonic wave S1-2 and the second ultrasonic wave S2-2, which are emitted from each of the band-like vibration regions Ag-2 of the panel 10-2, become the specific direction Sd.

The angle (hereinafter, may be referred to as “θs”) between the surface directions of the panels 10-1 and 10-2 is not limited to an angle of substantially 90 degrees. In other words, it is sufficient as long as the angle causes reflection of the first ultrasonic waves S1-1 and S1-2 and the second ultrasonic waves S2-1 and S2-2 that brings them close to one another, for providing a narrow directivity to the speaker apparatus 1 so as to improve sound emitting efficiency. For example, in a state where the above-mentioned “θd” is an angle of 45 degrees, when θs is set to more than an angle of 45 degrees and less than 135 degrees, the second ultrasonic wave S2-1 emitted from the panel 10-1 is able to be output in a direction away from the panel 10-2 and the second ultrasonic wave S2-2 emitted from the panel 10-2 is able to be output in a direction away from the panel 10-1.

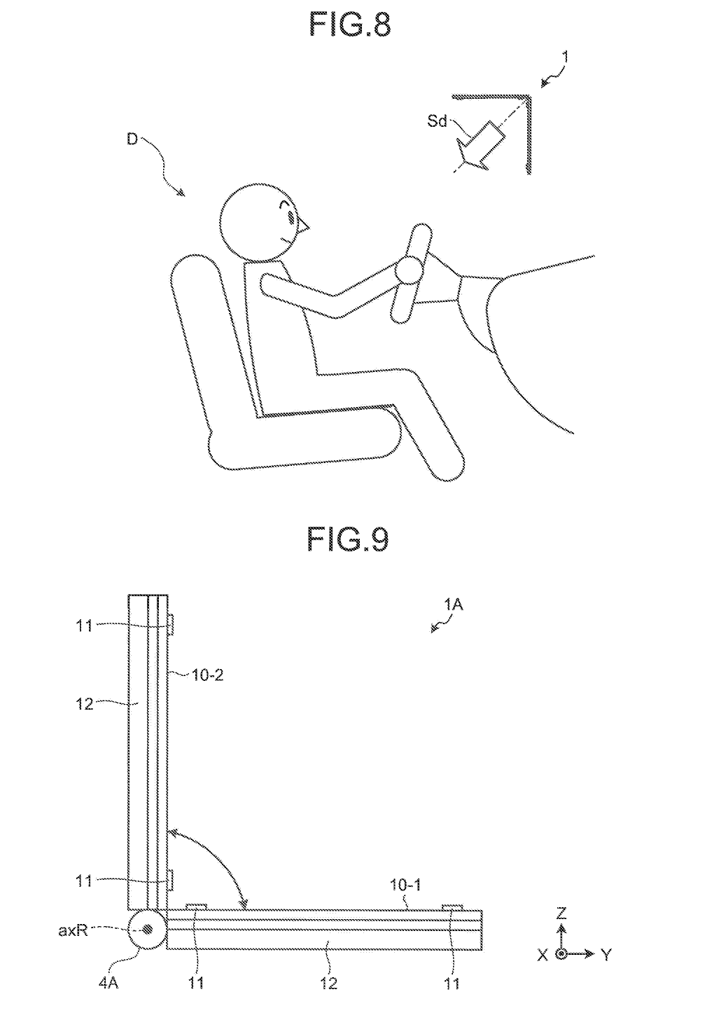

The speaker apparatus 1 configured in such a manner may be used as an on-vehicle speaker, for example. FIG. 8 is a diagram illustrating an arrangement example of the speaker apparatus 1 according to the first embodiment.

As illustrated in FIG. 8, when being used as an on-vehicle speaker, the speaker apparatus 1 is able to be arranged in a vehicle above a driver's seat, which is occupied by a driver D, so that the specific direction Sd directs the driver D, for example. Specifically, an arranged position of the speaker apparatus 1 is near a boundary between a ceiling and a windshield of the vehicle, for example. Thus, it is possible to provide an on-vehicle speaker having a narrow directivity toward the driver D.

As described above, the speaker apparatus 1 according to the first embodiment includes the panels 10-1 and 10-2 (one example of “first panel and second panel”), the vibration elements 11, and the drive unit 3. The vibration elements 11 are provided to each of the panels 10-1 and 10-2 to vibrate the panels 10-1 and 10-2.

The drive unit 3 applies the driving voltage Vo (one example “drive signal”) to the vibration elements 11 so as to respectively form the vibration regions As in the panels 10-1 and 10-2. The driving voltage Vo is obtained by modulating the carrier wave Sc in an ultrasonic band by using the sound signal Ss in an audible frequency band. The panels 10-1 and 10-2 are arranged so that an angle between surface directions of the panels 10-1 and 10-2 is a predetermined angle.

Thus, by employing the speaker apparatus 1 according to the present embodiment, it is possible to improve sound emitting efficiency.

The panel 10-2 is arranged along a direction intersecting with the panel 10-1 at the predetermined angle that is set so as to bring an advancing direction of a first ultrasonic wave and that of a second ultrasonic wave close to each other. The first ultrasonic wave is generated from the vibration region As of the panel 10-1 and reflected from the panel 10-2. The second ultrasonic wave is generated from the vibration region As of the panel 10-2 and reflected from the panel 10-1.

Thus, by employing the speaker apparatus 1 according to the present embodiment, one of the panels 10-1 and 10-2 is able to be used as a reflection plate of the other so as to bring advancing directions of ultrasonic waves emitted from the panels 10-1 and 10-2 close to each other, so that it is possible to improve sound emitting efficiency.

The predetermined angle is an angle of substantially 90 degrees. Therefore, by employing the speaker apparatus 1 according to the present embodiment, it is possible to correct emitting directions of the first ultrasonic wave S1 and the second ultrasonic wave S2, which are emitted from the respective panels 10-1 and 10-2, to the specific direction Sd. In other words, it is possible to reduce sound emission in needless directions so as to improve sound emitting efficiency.

The speaker apparatus 1 according to the present embodiment includes the panels 10-1 and 10-2, the vibration elements 11, and the drive unit 3. The vibration elements 11 are respectively provided to the panels 10-1 and 10-2 to vibrate the panels 10-1 and 10-2. The drive unit 3 applies the driving voltage Vo to the vibration elements 11 so as to respectively form the vibration regions As in the panels 10-1 and 10-2. The driving voltage Vo is obtained by modulating the carrier wave Sc in an ultrasonic band by using the sound signal Ss in an audible frequency band. Each of the pane 10-1 and 10-2 emits, from the corresponding panel surface thereof, sound waves having directivity in at least first and second directions. Each one of the panels 10-1 and 10-2 reflects at least the sound wave having directivity in the first direction that is emitted from the panel surface of the other of the panels 10-1 and 10-2 so as to synthesize the reflected sound wave and the sound wave having directivity in the second direction that is emitted from the corresponding one of the panels 10-1 and 10-2. In other words, the panels 10-1 and 10-2 are arranged to make the predetermined angle so that each one of the panels 10-1 and 10-2 reflects at least the sound wave having directivity in the first direction that is emitted from the panel surface of the other of the panels 10-1 and 10-2 so as to synthesize the reflected sound wave and the sound wave having directivity in the second direction that is emitted from the corresponding one of the panels 10-1 and 10-2.

Thus, by employing the speaker apparatus 1 according to the present embodiment, it is possible to improve sound emitting efficiency.

2. Second Embodiment

The above-mentioned connector 4 connects the panels 10-1 and 10-2 with each other to hold them; however, the connector 4 may be configured as an angle adjusting part 4A that is able to adjust an angle between the panels 10-1 and 10-2, for example.

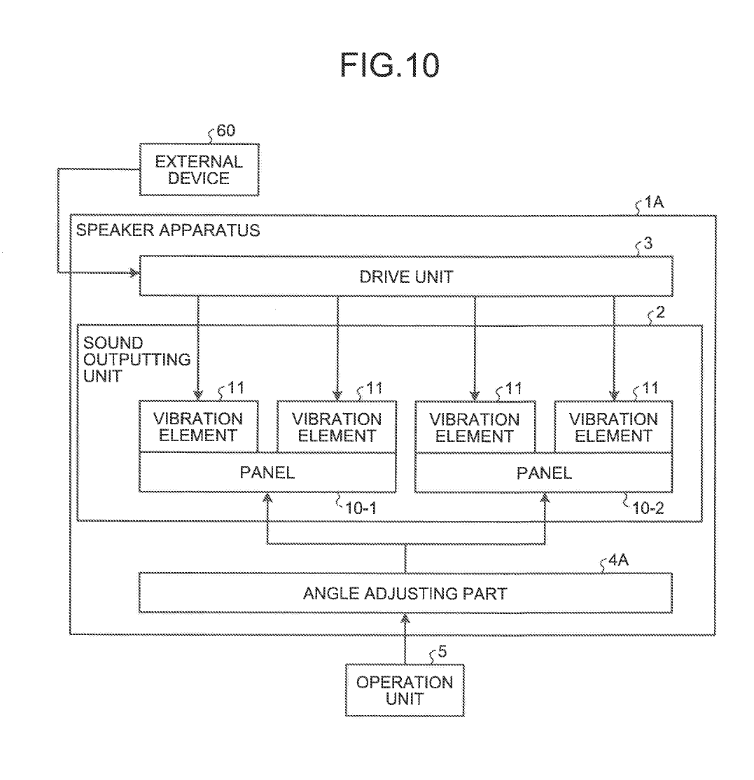

FIG. 9 is a schematic side view illustrating a speaker apparatus 1A according to a second embodiment. FIG. 10 is a block diagram illustrating the speaker apparatus 1A according to the second embodiment. FIG. 10 corresponds to FIG. 3, and thus configuration elements that are different from those depicted in FIG. 3 will be appropriately explained.

As illustrated in FIGS. 9 and 10, the speaker apparatus 1A according to the second embodiment includes the angle adjusting part 4A.

2.1. Angle Adjusting Part

The angle adjusting part 4A not only has a function of the connector 4 for connecting the panels 10-1 and 10-2, which are supported by the respective support parts 12, with each other to hold them, but also causes the panels 10-1 and 10-2 to open and close around an axis axR.

For example, the angle adjusting part 4A is constituted of a mechanism that is able to open and close, such as a hinge. The angle adjusting part 4A may include, for example, an actuator so as to cause the mechanism that is able to open and close to operate by using this actuator.

In this case, as illustrated in FIG. 10, the angle adjusting part 4A receives a user's operation via an operation unit 5, and drives, on the basis of an operation amount of the received operation, the actuator so as to adjust an angle between the surface directions of the panels 10-1 and 10-2. When not being provided the actuator, the operation unit 5 is a mechanical operation unit that includes an opening and closing mechanism such as a hinge.

As described above, when the angle between the panels 10-1 and 10-2 is adjustable by using the angle adjusting part 4A, it is possible to easily perform a fine adjustment due to individual difference of the panels 10-1 and 10-2. Moreover, it is possible to easily adjust a narrow directivity of the speaker apparatus 1A in accordance with a user's (for example, driver D illustrated in FIG. 8) taste and/or an audible position of the user.

As described above, the speaker apparatus 1A according to the second embodiment includes the angle adjusting part 4A that adjusts the angle between the surface directions of the respective panels 10-1 and 10-2.

Therefore, by employing the speaker apparatus 1A according to the present embodiment, it is possible to easily perform a fine adjustment due to individual difference of the panels 10-1 and 10-2. Moreover, is possible to easily adjust a narrow directivity of the speaker apparatus 1A in accordance with a user's taste and/or an audible position of the user.

In the above-mentioned embodiments, the case is exemplified in which the panels 10-1 and 10-2 are arranged close to each other; however, the panels 10-1 and 10-2 may be separately arranged if one of the panels 10-1 and 10-2 is able to use the other as a reflection plate.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A speaker apparatus comprising:
a first panel and a second panel;
vibration elements that are respectively provided to the first and second panels to vibrate the first and second panels; and
a drive unit that applies a drive signal to the vibration elements so as to respectively form vibration regions an the first and second panels, the drive signal being obtained by modulating a carrier wave in an ultrasonic band by using a sound signal in an audible frequency band, wherein
the first and second panels are arranged so that an angle between surface directions of the first and second panels is a predetermined angle.

2. The speaker apparatus according to claim 1, wherein
the second panel is arranged along a direction intersecting with the first panel at the predetermined angle that is set so as to bring an advancing direction of a first ultrasonic wave and that of a second ultrasonic wave close to each other, the first ultrasonic wave being generated from the vibration region of the first panel and reflected from the second panel, and the second ultrasonic wave being generated from the vibration region of the second panel and reflected from the first panel.

3. The speaker apparatus according to claim 1, wherein
the predetermined angle is substantially 90 degrees.

4. The speaker apparatus according to claim 2, wherein
the predetermined angle is substantially 90 degrees.

5. The speaker apparatus according to claim 1, further comprising:
an angle adjusting part that adjusts the angle between the surface directions.

6. The speaker apparatus according to claim 2, further comprising:
an angle adjusting part that adjusts the angle between the surface directions.

7. The speaker apparatus according to claim 3, further comprising:
an angle adjusting part that adjusts the angle between the surface directions.

8. The speaker apparatus according to claim 4, further comprising:
an angle adjusting Dart that adjusts the angle between the surface directions.

9. A speaker apparatus comprising:
a first panel and a second panel;
vibration elements that are respectively provided to the first and second panels to vibrate the first and second panels; and
a drive unit that applies a drive signal to the vibration elements so as to respectively form vibration regions in the first and second panels, the drive signal being obtained by modulating a carrier wave in an ultrasonic band by using a sound signal in an audible frequency band, wherein
each of the first and second panels emits, from the corresponding panel surface thereof, sound waves having directivity in at least first and second directions, and each one of the first and second panels reflects at least the sound wave having directivity in the first direction that is emitted from the panel surface of another of the first and second panels so as to synthesize the reflected sound wave and the sound wave having directivity in the second direction that is emitted from the corresponding one of the first and second panels.
